(19) United States
(12) Patent Application Publication
(10) Pub. No.: US 2017/0017903 A1
(43) Pub. Date: Jan. 19, 2017

(54) User Interface for a Unified Data Science Platform Including Management of Models, Experiments, Data Sets, Projects, Actions, Reports and Features

(71) Applicant: Skytree, Inc., San Jose, CA (US)

(72) Inventors: Alexander Gray, Santa Clara, CA (US); Sanjay Mehta, Fremont, CA (US)

(21) Appl. No.: 15/279,223

(22) Filed: Sep. 28, 2016

Related U.S. Application Data
(63) Continuation-in-part of application No. 15/042,086, filed on Feb. 11, 2016.
(60) Provisional application No. 62/233,969, filed on Sep. 28, 2015.
(60) Provisional application No. 62/115,135, filed on Feb. 11, 2015.

(51) Int. Cl. G06N 99/00; G06F 3/14; G06F 3/0482

(52) U.S. Cl. CPC G06N 99/005; G06F 3/0482; G06F 3/14

(57) ABSTRACT

A system and method for providing various intuitive user interfaces for data science process end-to-end is disclosed. In one implementation, the various intuitive user interfaces include a series of user interfaces associated with a unified, project-based data science workspace that guide a user through the data science process as well as learn from the user in the data science process.

### CROSS REFERENCE TO RELATED APPLICATIONS

The present application claims priority, under 35 U.S.C. §119, of U.S. Provisional Patent Application No. 62/233,969, filed Sep. 28, 2015 and entitled “Improved User Interface for a Unified Data Science Platform Including Management of Models, Experiments, Data Sets, Projects, Actions, Reports and Features,” which is incorporated by reference in its entirety.

The present application is also a continuation-in-part of U.S. patent application Ser. No. 15/042,086, filed Feb. 11, 2016 and entitled “User Interface for Unified Data Science Platform Including Management of Models, Experiments, Data Sets, Projects, Actions, Reports and Features,” which claims priority to U.S. Provisional Patent Application No. 62/115,135, filed Feb. 11, 2015 and entitled “User Interface for Unified Data Science Platform Including Management of Models, Experiments, Data Sets, Projects, Actions, Reports and Features.” The entireties of which are incorporated by reference herein.

### BACKGROUND OF THE INVENTION

1. Field of the Invention

The present specification is related to facilitating analysis of Big Data. More specifically, the present specification relates to systems and method for providing a unified data science platform. Still more particularly, the present specification relates to user interfaces for a unified data science platform including management of models, experiments, data sets, projects, actions, reports and features.

2. Description of Related Art

The model creation process of the prior art is often described as a black art. At best, it is slow, tedious and inefficient process. At worst, it compromises model accuracy and delivers sub-optimal results more often than not. This is all exacerbated when the data sets are massive in the case of Big Data analysis. Existing solutions fail to be intuitive to a novice user and burden the user with a learning curve that is intense and time consuming. Such a deficiency may lead to a decrease in user productivity as the user may waste effort trying to interpret the complexity inherent in data science without any success.

Thus, there is a need for a system and method that provides an enterprise class machine learning platform to automate data science and thus making machine learning much easier for enterprises to adopt and that provides intuitive user interfaces for the management and visualization of models, experiments, data sets, projects, actions, reports and features.

### SUMMARY OF THE INVENTION

The present disclosure overcomes one or more of the deficiencies of the prior art at least in part by providing a system and method for providing a unified, project-based data scientist workspace to visually prepare, build, deploy, visualize and manage models, their results and datasets.

According to one innovative aspect of the subject matter described in this disclosure, a system comprising one or more processors; and a memory including instructions that, when executed by the one or more processors, cause the system to: generate a user interface for presentation to a user, the user interface oriented around a first machine learning object in a data science process; determine a first context associated with the first machine learning object in the data science process; identify a second machine learning object related to the first machine learning object in the first context; generate a suggestion of a first action based on the first context; transmit, for display, the suggestion of the first action to the user on the user interface; receive, from the user, a confirmation to perform the first action; and manipulate one or more of the first machine learning object and the second learning object related to the first machine learning object in the first context based on the first action.

In general, another innovative aspect of the subject matter described in this disclosure may be embodied in methods that include generating a user interface for presentation to a user, the user interface oriented around a first machine learning object in a data science process; determining a first context associated with the first machine learning object in the data science process; identifying a second machine learning object related to the first machine learning object in the first context; generating a suggestion of a first action based on the first context; transmitting, for display, the suggestion of the first action to the user on the user interface; receiving, from the user, a confirmation to perform the first action; and manipulating one or more of the first machine learning object and the second learning object related to the first machine learning object in the first context based on the first action.

Other aspects include corresponding methods, systems, apparatus, and computer program products for these and other innovative features. These and other implementations may each optionally include one or more of the following features.

For instance, the operations further include generating a main workspace card including a snapshot of the first machine learning object and the first context associated with the first machine learning object in the data science process, the snapshot identifying one or more of an input and output of the first machine learning object, generating a dashboard card including a dynamic view of one or more key performance indicators for the first machine learning object in the data science process, generating a history card including a temporal history of commands applied to the one or more the first machine learning object and the second machine learning object related to the first machine learning object in the first context, generating a palette card including a list of reusable cards in the data science process, and placing the main workspace card, the dashboard card, the history card, and the palette card in a relative position with respect to each other on the user interface to receive user interaction for manipulating the one or more of the first machine learning object and the second machine learning object. For instance, the operations further include determining a first analysis phase of the first machine learning object and a history of analysis associated with the one or more of the first machine learning object and the second machine learning object related to the first machine learning object in the first context. For instance, the operations further include identifying a second action previously performed on another instance of the first machine learning object in a second analysis phase within a second context in the data science process, wherein the second analysis phase and the second context is identical to the first analysis phase and the first context, and first action is learned based on the second action. For instance, the operations further include selecting the suggestion based on one or more of seeded suggestions, heuristics, and a set of best practices in the data science process. For instance, the operations further include displaying a preview of an effect of the first action on the one or more of the first machine learning object and the second machine learning object related to the first machine learning object in the first context. For instance, the operations further include generating a checklist for the data science process based on one or more of learning from a previous checklist, seeded checklists, heuristics, and a set of best practices, the checklist identifying an overall progress of the data science process. For instance, the operations further include generating one or more report elements for inclusion in a report for the data science process responsive to receiving the confirmation to perform the first action. For instance, the operations further include generating a documentation of the first action in the data science process responsive to receiving the confirmation to perform the first action.

For instance, the features further include the suggestion of the first action including a sequence of actions comprising one or more of a demo, a lesson, and a tutorial for guiding the user in the data science process. For instance, the features further include the first machine learning object including one or more from a group of projects, datasets, workflows, code, model, deployment, knowledge, and jobs.

The present disclosure is particularly advantageous because it provides a unified, project-based data scientist workspace to visually prepare, build, deploy, visualize and manage models, their results and datasets. The unified workspace increases advanced data analytics adoption and makes machine learning accessible to a broader audience, for example, by providing a series of user interfaces to guide the user through the machine learning process in some embodiments. In some embodiments, the project-based approach allows users to easily manage items including projects, models, results, activity logs, and datasets used to build models, features, experiments, etc. In some embodiments, a user may be educated and/or guided through the process and provided suggestions with regard to a next step in the user's project, best practices, etc.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a block diagram illustrating an example of a system for a data science platform providing intuitive user interfaces for the data science process end-to-end in accordance with one implementation of the present disclosure.

FIG. 2 is a block diagram illustrating an example of a data science platform server in accordance with one implementation of the present disclosure.

FIG. 3 is a graphical representation of an example user interface highlighting a plurality of components and their functionality in the end-to-end data science process, in accordance with one implementation of the present disclosure.

FIG. 4 is a graphical representation of an example user interface documenting one or more reports in the data science process, in accordance with one implementation of the present disclosure.

FIG. 5 is a graphical representation of a user interface displaying report selection that can be specified via the inclusion or exclusion of desired report elements, in accordance with one implementation of the present disclosure.

FIG. 6 is a graphical representation of an example user interface displaying creation of reusable cards for inclusion in the palette area, in accordance with one implementation of the present disclosure.

FIG. 7 is a graphical representation of an example user interface associated with code in a data science process, in accordance with one implementation of the present disclosure.

FIG. 8 is a graphical representation of an example user interface tracking models in deployment, in accordance with one implementation of the present disclosure.

FIG. 9 is a graphical representation of an example user interface depicting a machine learning/data science scoreboard, in accordance with one implementation of the present disclosure.

FIG. 10 is a graphical representation of an example user interface depicting a knowledge base in the data science process, in accordance with one implementation of the present disclosure.

FIG. 11 is a graphical representation of an example user interface depicting inclusion of one or more knowledge base entries from the knowledge base into a report, in accordance with one implementation of the present disclosure.

FIG. 12 is a graphical representation of an example user interface displaying a next action suggestion to a user in the data science process, in accordance with one implementation of the present disclosure.

FIG. 13 is a graphical representation of an example user interface depicting a machine learning or data science diagnostic checklist, in accordance with one implementation of the present disclosure.

FIG. 14 is a flowchart of an example method for guiding a user through a data science process of a machine learning object, in accordance with one implementation of the present disclosure.

FIG. 15 is a flowchart of an example method for generating a user interface for facilitating a data science process of a machine learning object, in accordance with one implementation of the present disclosure.

### DETAILED DESCRIPTION

A system and method for providing one or more user interfaces under a unified platform for the data science process end-to-end is described. In the following description, for purposes of explanation, numerous specific details are set forth in order to provide a thorough understanding of the disclosure. It should be apparent, however, that the disclosure may be practiced without these specific details. In other instances, structures and devices are shown in block diagram form in order to avoid obscuring the disclosure. For example, the present disclosure is described in one implementation below with reference to particular hardware and software implementations. However, the present disclosure applies to other types of implementations distributed in the cloud, over multiple machines, using multiple processors or cores, using virtual machines or integrated as a single machine.

Reference in the specification to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation. In particular the present disclosure is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems should appear from the description below. In addition, the present disclosure is described without reference to any particular programming language. It should be appreciated that a variety of programming languages may be used to implement the teachings of the disclosure as described herein.

### Example System(s)

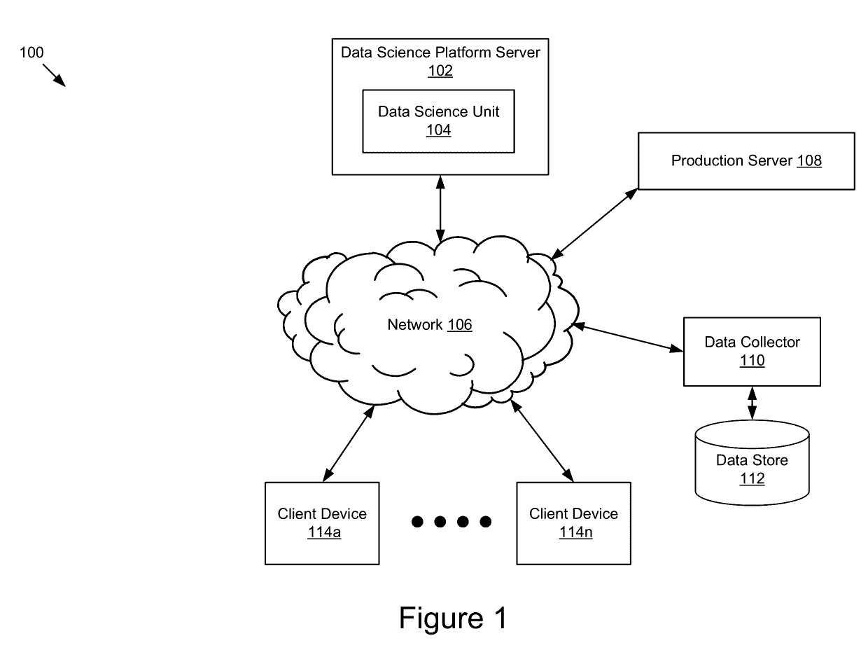

FIG. 1 is a block diagram illustrating an example of a system 100 for a uniform data science platform providing intuitive user interfaces for the data science process end-to-end in accordance with one implementation of the present disclosure. Referring to FIG. 1, the illustrated system 100 includes a data science platform server 102, a plurality of client devices 114a . . . 114n, a production server 108, a data collector 110 and associated data store 112. In FIG. 1 and the remaining figures, a letter after a reference number, e.g., “114a,” represents a reference to the element having that particular reference number. A reference number in the text without a following letter, e.g., “114,” represents a general reference to instance(s) of the element bearing that reference number. In the depicted implementation, the data science platform server 102, the production server 108, the plurality of client devices 114a . . . 114n, and the data collector 110 and associated data store 112 are communicatively coupled via a network 106.

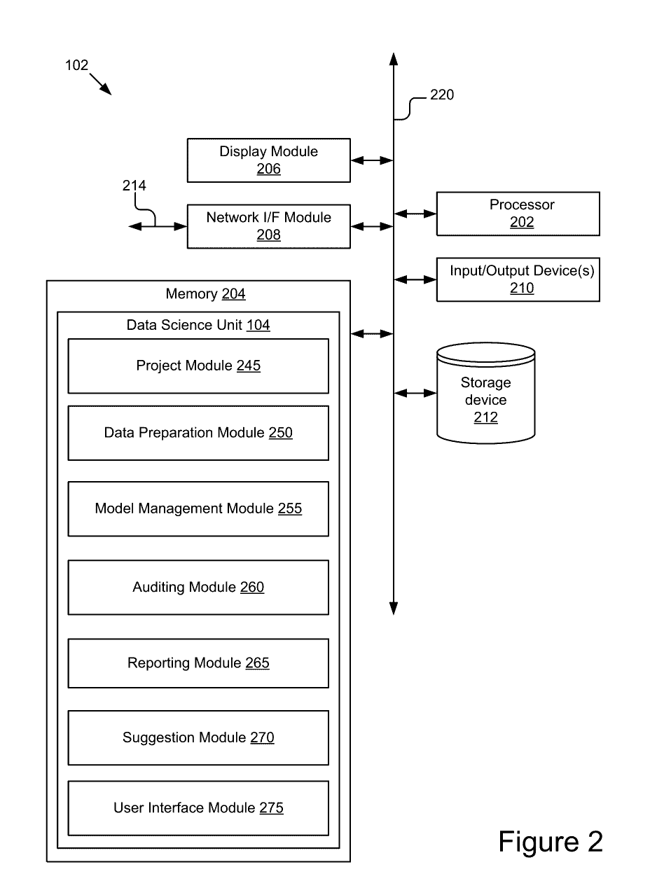

In some implementations, the system 100 includes a data science platform server 102 coupled to the network 106 for communication with the other components of the system 100, such as the plurality of client devices 114a . . . 114n, the production server 108, and the data collector 110 and associated data store 112. In some implementations, the data science platform server 102 may include a hardware server, a software server, or a combination of software and hardware. In some implementations, the data science platform server 102 is a computing device having data processing (e.g., at least one processor), storing (e.g., a pool of shared or unshared memory), and communication capabilities. For example, the data science platform server 102 may include one or more hardware servers, server arrays, storage devices and/or systems, etc. In the example of FIG. 1, the components of the data science platform server 102 may be configured to implement a data science unit 104 described in detail below with reference to FIG. 2 to provide the functionality and user interfaces (UIs) described disclosed herein. In some implementations, the data science platform server 102 provides services to a data analysis customer by providing intuitive user interfaces to at least partially automate end-to-end data science tasks under an extensible and unified data science platform. For example, the data science platform server 102 automates one or more data science operations such as model creation, model management, data preparation, report generations, visualizations and so on through user interfaces that change dynamically based on the context of the operation.

In some implementations, the data science platform server 102 may be a web server that couples with one or more client devices 114 (e.g., negotiating a communication protocol, etc.) and may prepare the data and/or information, such as forms, web pages, tables, plots, visualizations, etc. that is exchanged with one or more client devices 114. For example, the data science platform server 102 may generate a first user interface to allow the user to enact a data transformation on a set of data for processing and then return a second user interface to display the results of data transformation as applied to the submitted data. Also, instead of or in addition, the data science platform server 102 may implement its own API for the transmission of instructions, data, results, and other information between the data science platform server 102 and an application installed or otherwise implemented on the client device 114. Although only a single data science platform server 102 is shown in FIG. 1, it should be understood that there may be a number of data science platform servers 102 or a server cluster, which may be load balanced.

In some implementations, the system 100 includes a production server 108 coupled to the network 106 for communication with the other components of the system 100, such as the plurality of client devices 114a . . . 114n, the data science platform server 102, and the data collector 110 and associated data store 112. In some implementations, the production server 108 may be either a hardware server, a software server, or a combination of software and hardware. The production server 108 may be a computing device having data processing, storing, and communication capabilities. For example, the production server 108 may include one or more hardware servers, server arrays, storage devices and/or systems, etc. In some implementations, the production server 108 may include one or more virtual servers, which operate in a host server environment and access the physical hardware of the host server including, for example, a processor, memory, storage, network interfaces, etc., via an abstraction layer (e.g., a virtual machine manager). In some implementations, the production server 108 may include a web server (not shown) for processing content requests, such as a Hypertext Transfer Protocol (HTTP) server, a Representational State Transfer (REST) service, or other server type, having structure and/or functionality for satisfying content requests and receiving content from one or more computing devices that are coupled to the network 106 (e.g., the data science platform server 102, the data collector 110, the client device 114, etc.). In some implementations, the production server 108 may include machine learning models, receive a transformation sequence and/or machine learning models for deployment from the data science platform server 102 and generate predictions prescribed by the machine learning models, and use the transformation sequence and/or models on a test dataset (in batch mode or online) for data analysis. For purposes of this application, the terms “prediction” and “scoring” are used interchangeably to mean the same thing, namely, to turn predictions (in batch mode or online) using the model. In machine learning, a response variable, which may occasionally be referred to herein as a “response,” refers to a data feature containing the objective result of a prediction. A response may vary based on the context (e.g., based on the type of predictions to be made by the machine learning model). For example, responses may include, but are not limited to, class labels (classification), targets (generically, but particularly relevant to regression), rankings (ranking/recommendation), ratings (recommendation), dependent values, predicted values, or objective values. Although only a production server 108 is shown in FIG. 1, it should be understood that there may be a number of production servers 108 or a server cluster, which may be load balanced.

The data collector 110 is a server/service which collects data and/or analysis from other servers (not shown) coupled to the network 106. In some implementations, the data collector 110 may be a first or third-party server (that is, a server associated with a separate company or service provider), which mines data, crawls the Internet, and/or receives/retrieves data from other servers. For example, the data collector 110 may collect user data, item data, and/or user-item interaction data from other servers and then provide it and/or perform analysis on it as a service. In some implementations, the data collector 110 may be a data warehouse or belonging to a data repository owned by an organization. In some embodiments, the data collector 110 may receive data, via the network 106, from one or more of the data science platform server 102, a client device 114 and a production server 108. In some embodiments, the data collector 110 may receive data from real-time or streaming data sources.

The data store 112 is coupled to the data collector 108 and comprises a non-volatile memory device or similar permanent storage device and media. The data collector 110 stores the data in the data store 112 and, in some implementations, provides access to the data science platform server 102 to retrieve the data collected by the data store 112 (e.g. training data, response variables, rewards, tuning data, test data, user data, experiments and their results, learned parameter settings, system logs, etc.).

Although only a single data collector 110 and associated data store 112 is shown in FIG. 1, it should be understood that there may be any number of data collectors 110 and associated data stores 112. In some implementations, there may be a first data collector 110 and associated data store 112 accessed by the data science platform server 102 and a second data collector 110 and associated data store 112 accessed by the production server 108. It should also be recognized that a single data collector 110 may be associated with multiple homogenous or heterogeneous data stores (not shown) in some embodiments. For example, the data store 112 may include a relational database for structured data and a file system (e.g. HDFS, NFS, etc.) for unstructured or semi-structured data. It should also be recognized that the data store 112, in some embodiments, may include one or more servers hosting storage devices (not shown).

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another implementation, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, wireless application protocol (WAP), electronic mail, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the data science platform server 102 and/or other components (e.g., 108, 110) of the system 100 may communicate and interact with a multiplicity of users on a multiplicity of client devices 114a . . . 114n. In some implementations, the plurality of client devices 114a . . . 114n may include a browser application through which a client device 114 interacts with the data science platform server 102, an application installed enabling the client device 114 to couple and interact with the data science platform server 102, may include a text terminal or terminal emulator application to interact with the data science platform server 102, or may couple with the data science platform server 102 in some other way. In the case of a standalone computer embodiment of the uniform data science platform system 100, the client device 114 and data science platform server 102 are combined together and the standalone computer may, similar to the above, generate a user interface either using a browser application, an installed application, a terminal emulator application, or the like. In some implementations, the plurality of client devices 114a . . . 114n may support the use of Application Programming Interface (API) specific to one or more programming platforms to allow the multiplicity of users to develop program operations for analyzing, visualizing and generating reports on items including datasets, models, results, features, etc. and the interaction of the items themselves.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different embodiments of the system 100 that include the network 106, the data science platform server 102, the production server 108, the data collector 110 and associated data store 112, and one or more client devices 114. In a first example, the data science platform server 102, the production server 108, and the data collector 110 may each be dedicated devices or machines coupled for communication with each other by the network 106. In a second example, any one or more of the servers 102, 108, and 110 may each be dedicated devices or machines coupled for communication with each other by the network 106 or may be combined as one or more devices configured for communication with each other via the network 106. For example, the data science platform server 102 and the production server 108 may be included in the same server. In a third example, any one or more of the servers 102, 108, and 110 may be operable on a cluster of computing cores in the cloud and configured for communication with each other. In a fourth example, any one or more of one or more servers 102, 108, and 110 may be virtual machines operating on computing resources distributed over the internet. In a fifth example, any one or more of the servers 102 and 108 may each be dedicated devices or machines that are firewalled or completely isolated from each other (i.e., the servers 102 and 108 may not be coupled for communication with each other by the network 106). For example, the data science platform server 102 and the production server 108 may be included in different servers that are firewalled or completely isolated from each other.

While the data science platform server 102 and the production server 108 are shown as separate devices in FIG. 1, it should be understood that in some embodiments, the data science platform server 102 and the production server 108 may be integrated into the same device or machine. Particularly, where the data science platform server 102 and the production server 108 are performing online learning, a unified configuration may be preferred. While the system 100 shows only one device 102, 106, 108, 110 and 112 of each type, it should be understood that there could be any number of devices of each type to collect and provide information. Moreover, it should be understood that some or all of the elements of the system 100 could be distributed and operate on a cluster or in the cloud using the same or different processors or cores, or multiple cores allocated for use on a dynamic as needed basis. Furthermore, it should be understood that the data science platform server 102 and the production server 108 may be firewalled from each other and have access to separate data collector 110 and associated data store 112. For example, the data science platform server 102 and the production server 108 may be in a network isolated configuration.

### Example Recommendation Server 102

Referring now to FIG. 2, an embodiment of a data science platform server 102 is described in more detail. The data science platform server 102 comprises a processor 202, a memory 204, a display module 206, a network I/F module 208, an input/output device 210 and a storage device 212 coupled for communication with each other via a bus 220. The data science platform server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the data science platform server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. The processor 202 may also include an operating system executable by the processor 202 such as but not limited to WINDOWS®, Mac OS®, or UNIX® based operating systems. In some implementations, the processor(s) 202 may be coupled to the memory 204 via the bus 220 to access data and instructions therefrom and store data therein. The bus 220 may couple the processor 202 to the other components of the data science platform server 102 including, for example, the display module 206, the network I/F module 208, the input/output device(s) 210, and the storage device 212.

The memory 204 may store and provide access to data to the other components of the data science platform server 102. The memory 204 may be included in a single computing device or a plurality of computing devices. In some implementations, the memory 204 may store instructions and/or data that may be executed by the processor 202. For example, as depicted in FIG. 2, the memory 204 may store the data science unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of data science platform server 102.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In some implementations, the memory 204 also includes a non-volatile memory such as a hard disk drive or flash drive for storing information on a more permanent basis. The memory 204 is coupled by the bus 220 for communication with the other components of the data science platform server 102. It should be understood that the memory 204 may be a single device or may include multiple types of devices and configurations.

The display module 206 may include software and routines for sending processed data, analytics, or results for display to a client device 114, for example, to allow an administrator to interact with the data science platform server 102. In some implementations, the display module may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. In some implementations, the network I/F module 208 also provides other conventional connections to the network 106 for distribution of files using standard network protocols such as transmission control protocol and the Internet protocol (TCP/IP), hypertext transfer protocol (HTTP), hypertext transfer protocol secure (HTTPS) and simple mail transfer protocol (SMTP) as should be understood to those skilled in the art. In some implementations, the network I/F module 208 is coupled to the network 106 by a wireless connection and the network I/F module 208 includes a transceiver for sending and receiving data. In such an alternate implementation, the network I/F module 208 includes a Wi-Fi transceiver for wireless communication with an access point. In another alternate implementation, the network IF module 208 includes a Bluetooth® transceiver for wireless communication with other devices. In yet another implementation, the network I/F module 208 includes a cellular communications transceiver for sending and receiving data over a cellular communications network such as via short messaging service (SMS), multimedia messaging service (MMS), hypertext transfer protocol (HTTP), direct data connection, wireless application protocol (WAP), email, etc. In still another implementation, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the data science platform server 102 and may be coupled to the system either directly or through intervening I/O controllers. An input device may be any device or mechanism of providing or modifying instructions in the data science platform server 102. For example, the input device may include one or more of a keyboard, a mouse, a scanner, a joystick, a touchscreen, a webcam, a touchpad, a touchscreen, a stylus, a barcode reader, an eye gaze tracker, a sip-and-puff device, a voice-to-text interface, etc. An output device may be any device or mechanism of outputting information from the data science platform server 102. For example, the output device may include a display device, which may include light emitting diodes (LEDs). The display device represents any device equipped to display electronic images and data as described herein. The display device may be, for example, a cathode ray tube (CRT), liquid crystal display (LCD), projector, or any other similarly equipped display device, screen, or monitor. In one implementation, the display device is equipped with a touch screen in which a touch sensitive, transparent panel is aligned with the screen of the display device. The output device indicates the status of the data science platform server 102 such as: 1) whether it has power and is operational; 2) whether it has network connectivity; 3) whether it is processing transactions. Those skilled in the art should recognize that there may be a variety of additional status indicators beyond those listed above that may be part of the output device. The output device may include speakers in some implementations.

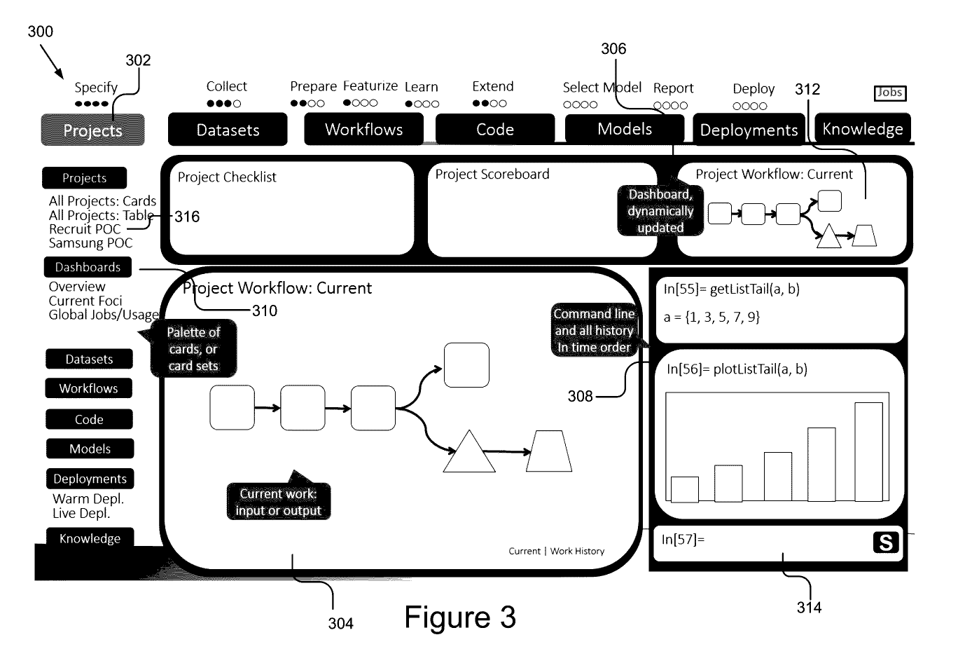

The storage device 212 is an information source for storing and providing access to data, such as the data described in reference to FIGS. 3-13 and including a plurality of datasets, transformations, model(s), reports, projects, and workflows associated with the plurality of datasets. The data stored by the storage device 212 may be organized and queried using various criteria including any type of data stored by it. The storage device 212 may include data tables, databases, or other organized collections of data. The storage device 212 may be included in the data science platform server 102 or in another computing system and/or storage system distinct from but coupled to or accessible by the data science platform server 102. The storage device 212 may include one or more non-transitory computer-readable mediums for storing data. In some implementations, the storage device 212 may be incorporated with the memory 204 or may be distinct therefrom. In some implementations, the storage device 212 may store data associated with a database management system (DBMS) operable on the data science platform server 102. For example, the storage device 212 could include a structured query language (SQL) RDBMS, a NoSQL DBMS, various combinations thereof, etc. In some instances, the storage device 212 may store data in multi-dimensional tables comprised of rows and columns, and manipulate, e.g., insert, query, update and/or delete, rows of data using programmatic operations. In some implementations, the storage device 212 may store data associated with a Hadoop distributed file system (HDFS) or a cloud based storage system such as Amazon™ S3.

The bus 220 represents a shared bus for communicating information and data throughout the data science platform server 102. The bus 220 may represent one or more buses including an industry standard architecture (ISA) bus, a peripheral component interconnect (PCI) bus, a universal serial bus (USB), or some other bus known in the art to provide similar functionality which is transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the data science platform server 102 (operating systems, device drivers, etc.), and any of the components of the data science unit 104 may cooperate and communicate via a communication mechanism included in or implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the data science unit 104 may include and may signal the following to perform their functions: a project module 245 that manages and organizes a project based data science automation process, a data preparation module 250 that prepares a dataset for the data science process, a model management module 255 that manages the training, testing and tuning of models, an auditing module 260 that generates an audit trail for documenting changes in datasets, transformation, results, and other machine learning objects, a reporting module 265 that generates reports, visualizations plots on items, a suggestion module 270 that generates a suggestion of next action to the user, and a user interface module 275 that cooperates and coordinates with other components of the data science unit 104 to generate a user interface that may present the user experiments, features, models, data sets, or projects. In one embodiment, a model may be immutable once generated. These components 245, 250, 255, 260, 265, 270, 275, and/or components thereof, may be communicatively coupled by the bus 220 and/or the processor 202 to one another and/or the other components 206, 208, 210, and 212 of the data science platform server 102. In some implementations, the components 245, 250, 255, 260, 265, 270, and/or 275 may include computer logic (e.g., software logic, hardware logic, etc.) executable by the processor 202 to provide their acts and/or functionality. In any of the foregoing implementations, these components 245, 250, 255, 260, 265, 270, and/or 275 may be adapted for cooperation and communication with the processor 202 and the other components of the data science platform server 102.

It should be recognized that the data science unit 104 and disclosure herein applies to and may work with Big Data, which may have billions or trillions of elements (rows×columns) or even more, and that the user interface elements are adapted to scale to deal with such large datasets, resulting large models and results and provide visualization, while maintaining intuitiveness and responsiveness to interactions.

The project module 245 includes computer logic executable by the processor 202 to manage and organizes a project based data science automation process. In some implementations, the project module 245 exposes machine learning objects for user interaction in the data science process. The machine learning objects in the data science process include, for example, projects, datasets, workflows, code, models, deployment, knowledge, and jobs. In some implementations, the project module 245 sends instructions to the user interface module 275 to generate a user interface to orient around, display and/or expose the machine learning objects as different cards, or entries in a table. For example, the user interface may show a plurality of proof-of-concept projects initiated by an enterprise as different cards, or entries in a table of projects. Furthermore, each project may include one or more contextually related machine learning objects, such as datasets, workflows, models, and users who have access to the project.

In some implementations, the project module 245 handles the specification of a checklist for a project. The checklist clarifies and organizes information or data for completing the project in the data science workflow. The checklist represent phases of analytics work and/or analytics diagnostics. The phases of analytics work are parts of the overall analytics work in a project. For example, the phases include, but are not limited to, project specification, data collection, data preparation, data featurization, training of models, selection of models, reporting of models, and deployment of models. The project module 245 includes a specification of diagnostics in the checklist. The diagnostics are validation steps which are prescribed as necessary or desirable to perform, for example, checking for the presence of outliers in the training data. Each diagnostic may include a set of visualizations/plots to be created, a set of statistics to be computed, and thresholds or other conditions on those statistics that define whether the diagnostic has been passed (or any subset of these three). The project module 245 monitors these statistics and thresholds and can automatically check a machine learning object, such as a workflow to see which diagnostics have been passed. The checklist may help the data science project be error-checkable, progress-trackable, and a structured process. In some implementations, the phases of the analytics work are customizable to meet demands of each individual group or enterprise involved in the data science process. In some implementations, the project module 245 sends instructions to the user interface module 275 to generate a user interface that provides a way for a user to create or modify a checklist, and view the status of a checklist (which items have been checked off, and when, and by whom, and a timeline by which they should be checked off). A checklist can be shown in a horizontal or vertical fashion, indicating the overall progress of the machine learning/data science project.

One of the checklist items can be the specification of the project. The project module 245 receives a specification including a primary objective of the project from a user. For example, the primary objective may be a quantitative metric such as predictive accuracy, and may include constraints based on other metrics. The constraints may dictate, for example, that the scoring time of the final model in the project must be less than a specified threshold. In another example, the quantitative metric may be a metric which combines multiple metrics, such as a weighted combination of more than one quantitative values. The specification of the project may also include values/costs such as the entries in a classification cost matrix. In another example, the specification of the project may also include the specification of the generalization mechanism (e.g. 10-fold cross-validation). In some implementations, the project module 245 generates the checklist that is hierarchically. For example, the checklist includes a diagnostic, which itself may be comprised of sub-diagnostics which check more detailed issues.

In some implementations, the project module 245 receives data science tags for a plurality of machine learning objects from one or more users of a project. For example, each type of object (e.g., projects, datasets, workflows, code, models, deployments, knowledge, jobs, features, cards) may have tags associated with it, which may be pre-assigned in the data science process or created by users participating in the project. Tags may be searched, edited, filtered, and viewed by the user. In some implementations, the project module 245 configures pre-condition and post-conditions for the machine learning object manipulated in the project. For example, a machine learning object, such as a workflow may have its pre-conditions or post-conditions specified in a standardized representation or set of representations. The pre-conditions and post-conditions may be preconfigured by the data science process or user specified. The pre-conditions and post-conditions inform the data science process of what is the input and/or output of each machine learning object and what the result of interaction of two or more machine learning objects should be, for error checking and automation in the data science process.

The data preparation module 250 includes computer logic executable by the processor 202 to receive a request from a user to import a dataset from various information sources, such as computing devices (e.g. servers) and/or non-transitory storage media (e.g., databases, Hard Disk Drives, etc.). In some implementations, the data preparation module 250 imports data from one or more of the servers 108, the data collector 110, the client device 114, and other content or analysis providers. For example, the data preparation module 250 may import a local file. In another example, the data preparation module 250 may link to a dataset from a non-local file (e.g. a Hadoop distributed file system (HDFS)). In some implementations, the data preparation module 250 processes a sample of the dataset and sends instructions to the user interface module 275 to generate a preview of the sample of the dataset. The data preparation module 250 manages the one or more datasets in a project and performs special data preparation processing to import the external file during the import of the dataset. In some implementations, the data preparation module 250 processes the dataset to retrieve metadata. For example, the metadata can include, but is not limited to, name of the feature or column, a type of the feature (e.g., integer, text, etc.), whether the feature is categorical (e.g., true or false), a distribution of the feature in the dataset based on whether the data state is sample or full, a dictionary (e.g., when the feature is categorical), a minimum value, a maximum value, mean, standard deviation (e.g. when the feature is numerical), etc. In some implementations, the data preparation module 250 scans the dataset on import and automatically infers the data types of the columns in the dataset based on rules and/or heuristics and/or dynamically using machine learning. For example, the data preparation module 250 may identify a column as categorical based on a rule. In another example, the data preparation module 250 may determine that 80 percent of the values in a column to be unique and may identify that column to be an identifier type column of the dataset. In yet another example, the data preparation module 250 may detect time series of values, monotonic variables, etc. in columns to determine appropriate data types. In some implementations, the data preparation module 250 determines the column types in the dataset based on machine learning on data from past usage. In some implementations, the data preparation module 250 sends instructions to the user interface module 275 to generate a user interface oriented around the dataset as a machine learning object and display features generated for the dataset for user interaction.

The model management module 255 includes computer logic executable by the processor 202 for generating one or more models based on the data prepared by the data preparation module 250 in the project of the data science process. In some implementations, the model management module 255 includes a one-step process to train, tune and test models. The model management module 255 may use any number of various machine learning techniques to generate a model. In some implementations, the model management module 255 automatically and simultaneously selects between distinct machine learning models and finds optimal model parameters for various machine learning tasks. Examples of machine learning tasks include, but are not limited to, classification, regression, and ranking. The performance can be measured by and optimized using one or more measures of fitness. The one or more measures of fitness used may vary based on the specific goal of a project. Examples of potential measures of fitness include, but are not limited to, error rate, F-score, area under curve (AUC), Gini, precision, performance stability, time cost, etc. In some implementations, the model management module 255 provides the machine learning specific data transformations used most by data scientists when building machine learning models, significantly cutting down the time and effort needed for data preparation on big data.

In some implementations, the model management module 255 identifies variables or columns in a dataset that were important to the model being built and sends the variables to the reporting module 265 for creating partial dependence plots (PDP). In some implementations, the model management module 255 analyses the data of the built model and sends the data to the reporting module 265 for creating diagnostic reports. In some implementations, the model management module 255 determines the tuning results of models being built and sends the information to the user interface module 275 for display. In some implementations, the model management module 255 stores the one or more models in the storage device 212 for access by other components of the data science unit 104. In some implementations, the model management module 255 performs testing on models using test datasets, generates results and stores the results in the storage device 212 for access by other components of the data science unit 104.

In some implementations, the model management module 255 manages and builds a workflow in the project. The workflow may or may not include a model. The model management module 255 monitors the building and exporting of the workflow and sends data to the auditing module 260 for building an audit trail changes that have transpired in the building and exporting of the workflow. For example, the workflow may be a complex transformation composed of individual, simpler transformations. In another example, a user-developed transformation may be a workflow that is composed of column extraction transformation, column addition transformation, column subtraction transformation, etc. In another example, the workflow can be a subset of one or more transformations from a data transformation pipeline, which may also occasionally be referred to herein as a transformation workflow, project workflow or similar, exported by a user. In another example, the workflow may be a machine learning model that can be an input to another workflow.

In some implementations, the model management module 255 may deploy and manage models in a training and/or production environment. The model management module 255 sends instructions to the user interface module 275 to generate a user interface for displaying a scoreboard of the models, or experiments involving models. The model management module 255 sends instructions to the user interface module 275 to generate a user interface for displaying information relating to deployment of models.

The auditing module 260 includes computer logic executable by the processor 202 to create a full audit trail of models, projects, datasets, results and other machine learning objects in a data science project. In some implementations, the auditing module 260 creates self-documenting models with an audit trail. Thus, the auditing module 260 improves model management and governance with self-documenting models, which includes a full audit trail. The auditing module 260 generates an audit trail for items so that they may be reviewed to see when/how they were changed and who made the changes to, for example, the machine learning object. Moreover, models generated by the model management module 255 automatically document all datasets, transformations, commands, algorithms and results, which are displayed in an easy to understand visual format. In some implementations, the auditing module 260 sends instructions to the user interface module 275 to generate a user interface that displays a running log or history of actions (by user or as part of the automated data analysis process) with respect to the machine learning object of the data science project. The auditing module 260 tracks all changes and creates a full audit trail that includes information on what changes were made (i.e., using commands programmatically or via the user interface), when and by whom. The audit trail or the auto-documentation explains what was done, in digestible chunks that provide clarity. The audit trail can be shared with other users or regulatory bodies. This level of model management and governance is critical for data science teams working in enterprises of all sizes, including regulated industries. The auditing module 260 also provide the rewind function that allows a user to re-create any past pipelines. The auditing module 260 also tracks software versioning information. The auditing module 260 also records the provenance of data sets, models and other files. The auditing module 260 also provides for file importation and review of files or previous versions.

The reporting module 265 includes computer logic executable by the processor 202 for generating reports, visualizations, and plots on items including models, datasets, results, etc. In some implementations, the reporting module 265 determines a visualization that is a best fit based on variables being compared. For example, in partial dependence plot visualization, if the two PDP variables being compared are categorical-categorical, then the plot may be heat map visualization. In another example, if the two PDP variables being compared are continuous-categorical, then the plot may be a bar chart visualization. In some implementations, the reporting module 265 receives one or more custom visualizations developed in different programming platforms from the client devices 114, receives metadata relating to the custom visualizations and adds the visualizations to the visualization library, and makes the visualizations accessible across project-to-project, model-to-model or user-to-user through the visualization library.

In some implementations, the reporting module 265 cooperates with the user interface module 275 to identify any information provided in the user interfaces to be output in a report format individually or collectively. Moreover, the visualizations, the interaction of the items (e.g., experiments, features, models, data sets, and projects), the audit trail or any other information provided by the user interface module 275 can be output as a report. For example, the reporting module 265 allows for the creation of directed acyclic graph (DAG) and a representation of it in the user interface as shown below in example of FIGS. 3, 5-6, and 11-12. The reporting module 265 generates the reports in any number of formats including, MS-PowerPoint, portable document format, HTML, XML, etc. In some implementations, the reporting module 265 receives a selection of report elements (plots, visualizations, diagnostics, etc.) from the user for inclusion in a report format. In other implementations, the reporting module 265 learns from reports generated for other projects in a similar data science phase and/or in a similar context and uses those reports or report elements as templates for a current project under consideration in the data science process.

In some implementations, the modules 250, 255, and 265 may receive user defined code sequences that manipulate the dataset, the model, and the plot visualization of one or more of the objects in the data science project. The modules 250, 255, and 265 send instructions to the user interface module 275 to generate a user interface that integrates coding where the user may edit of the code sequence. This integration addresses a large span of skills, allows customization of the data science process. The modules 250, 255, and 265 send instructions to the user interface module 275 to update the user interface with generated report elements indicating, for example, the successful debugging or wrapping of the code sequence for use in the data science project.

The suggestion module 270 includes computer logic executable by the processor 202 for generating a suggestion of a next action to interactively guide the user in the data science process. The suggestion may be used to teach the user why the action is preferred in a particular juncture of the data analysis in the project. For example, the suggestion may help ensure a good outcome in the project, prevent the user from getting stalled in the data science process, and raise the skill level of the user to create a trained user. The suggestion module 270 determines a context of one or more related machine learning objects and generates the suggestion of a next action based on the context. The context identifies an analysis phase of the data science process involving the one or more related machine learning objects. The context also considers a history of analysis performed on the one or more related machine learning objects.

In some implementations, the suggestion module 270 selects the suggestion from one or more of seeded suggestions, heuristics, and a set of best practices. In some implementations, the suggestion module 270 learns the actions of one or more other users (e.g. an expert user) in similar context, and generates a next action suggestion for a novice user based on learning the actions (e.g. those of the expert user). In some implementations, the suggestion module 270 sends instructions to the user interface module 275 to generate a user interface that includes an option (which may appear as a button or other interaction cue) for the user to select to receive a suggestion of a next action. In some implementations, a user may repeatedly select the option and the user interface module 275 generates successive steps guiding the user through the machine learning/data science process from end-to-end.

In some implementations, the suggestion module 270 accesses a knowledge base for machine learning/data science and select a knowledge element from the knowledge base. The suggestion module 270 bundles the suggestions with an appropriate knowledge element to describe a reasoning behind the suggestions. The knowledge base is user-editable in some implementations. The suggestion module 270 receives a question-and-answer knowledge from a user and adds the knowledge to the knowledge base for other users to access. In some implementations, the suggestion module 270 may specify a sequence of actions as suggestions, thus constituting the equivalent of a lesson or demo. The lesson or demo may guide the user through both the knowledge elements and the associated software actions, and the user learns the data science process taught by the lesson or demo by doing as per the suggestions.

In some implementations, the suggestion module 270 maintains a machine learning/data science point system within the knowledge base. The point system may encourage certain user behaviors by displaying an amount of “points” gained by the user and stored by the point system, for example for completing or passing certain lessons or demos, for creating and teaching lessons or demos, for adding knowledge nodes to the knowledge base, for creating models which perform well compared to others on scoreboards, or for performing more actions in the data science process, for performing other actions in the data science process, or for performing any other action associated or not associated with the product or the company, or any subset of these. Such points may be used to compare to other users' points, gain rewards which may be monetary or other gifts or rights, or exchange with other users. They may be bought for real currency or sold for real currency.

The user interface module 275 includes computer logic executable by the processor 202 for creating any or all of the user interfaces illustrated in FIGS. 3-13 and providing optimized user interfaces, control buttons and other mechanisms. In some implementations, the user interface module 275 provides a unified, project-based data scientist workspace to visually prepare, build, deploy, visualize and manage models. The unified workspace increases advanced data analytics adoption and makes machine learning accessible to a broader audience, for example, by providing a series of user interfaces to guide the user through the machine learning process in some embodiments. The project-based approach allows users to easily manage items including projects, models, results, activity logs, and datasets used to build models, features, experiments, etc. In one embodiment, the user interface module 275 provides at least a subset of the items in a table or database of each of the items with the controls and operations applicable to the items. Examples of the unified workspace are shown in user interfaces illustrated in FIGS. 3-13 and described in detail below.

In some implementations, the user interface module 275 cooperates and coordinates with other components of the data science unit 104 to generate a user interface that allows the user to perform operations on experiments, features, models, data sets, deployment, projects, and other machine learning objects in the same or different user interface. This is advantageous because it may allow the user to perform operations and modifications to multiple items at the same time. The user interface includes graphical elements that are interactive. The user interface is adaptive. The graphical elements can include, but are not limited to, radio buttons, selection buttons, checkboxes, tabs, drop down menus, scrollbars, tiles, text entry fields, icons, graphics, directed acyclic graph (DAG), plots, tables, etc.

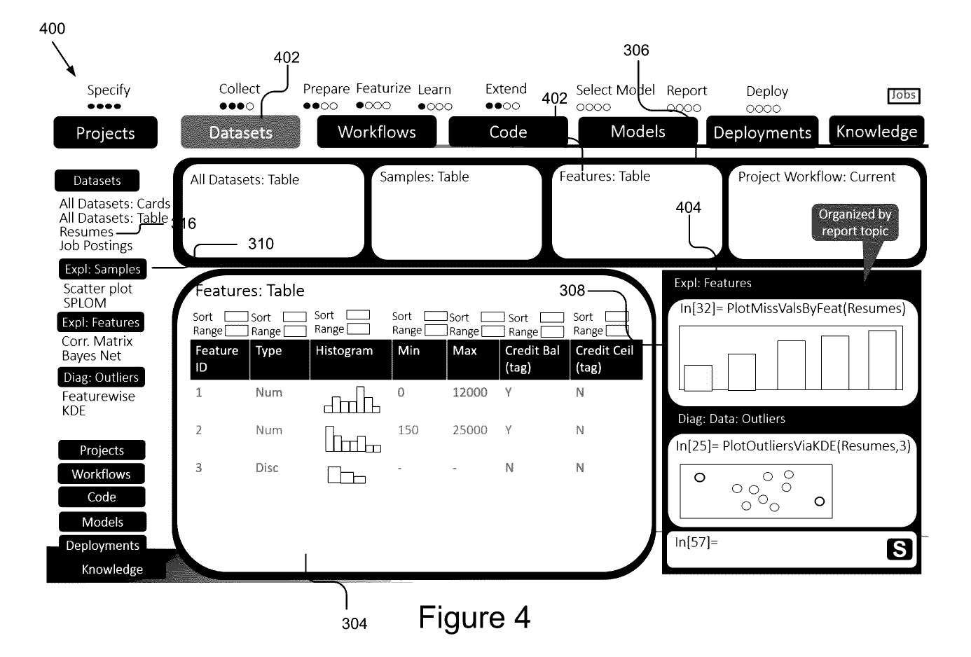

In some implementations, the user interface module 275 receives processed information of a dataset from the data preparation module 250 and generates a user interface for representing the features of the dataset. The processed information may include, for example, a preview of the dataset that can be displayed to the user in the user interface. In one embodiment, the preview samples a set of rows from the dataset which the user may verify and then confirm in the user interface for including a plot of the data features into a report as shown in the example of FIG. 4.

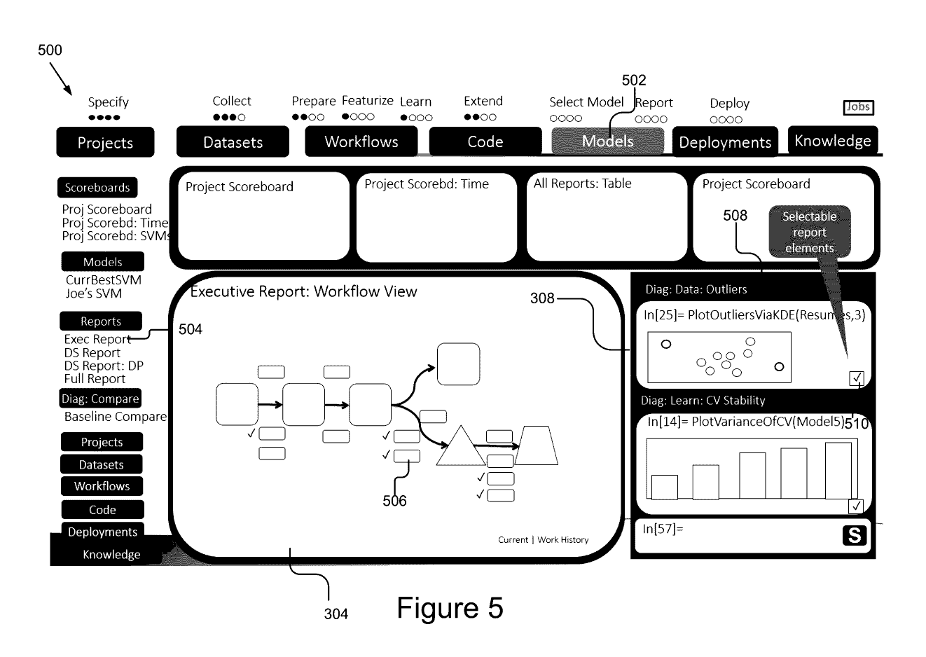

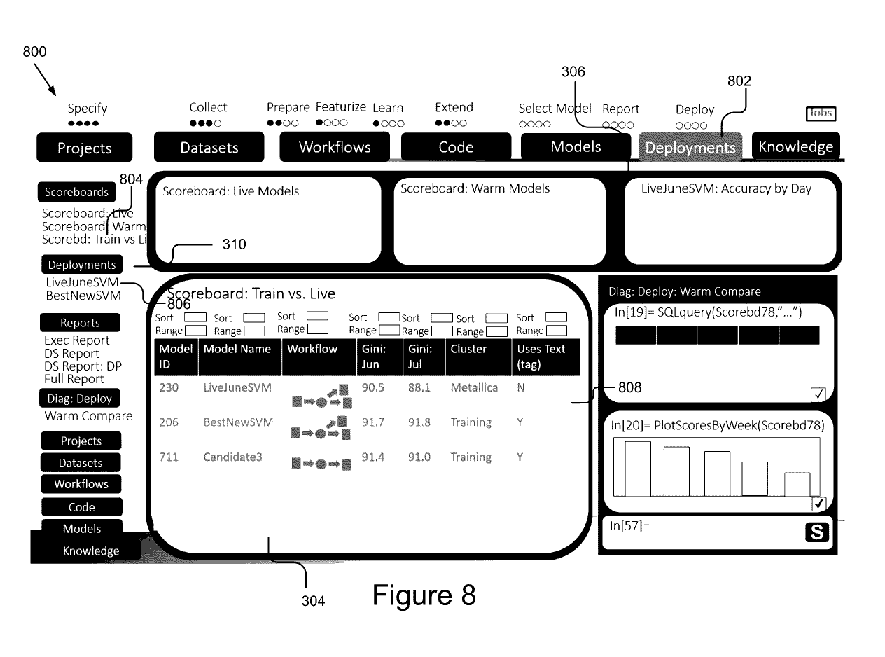

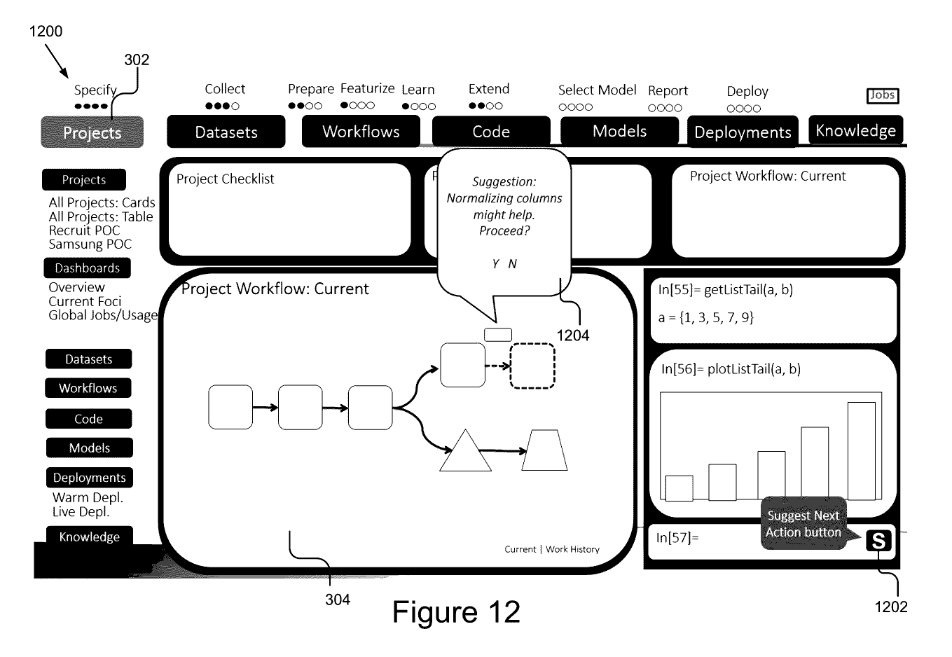

In some implementations, the user interface module 275 cooperates with other components of the data science unit 104 to recommend a next, suggested action to the user on the user interface. In some implementations, the user interface module 275 generates a user interface including a suggestion box that serves as a guiding wizard in building a model as shown in the example of FIG. 12. The user interface module 275 receives a set of machine learning models in deployment from the model management module 255 and updates the user interface to include the models in a scoreboard for the user to review as shown in the example of FIG. 8. The user interface module 275 receives information about the models from the model management module 255 and the updates the user interface to include a diagnostic report, which the user can then select to include into a report as shown in the example of FIG. 5.

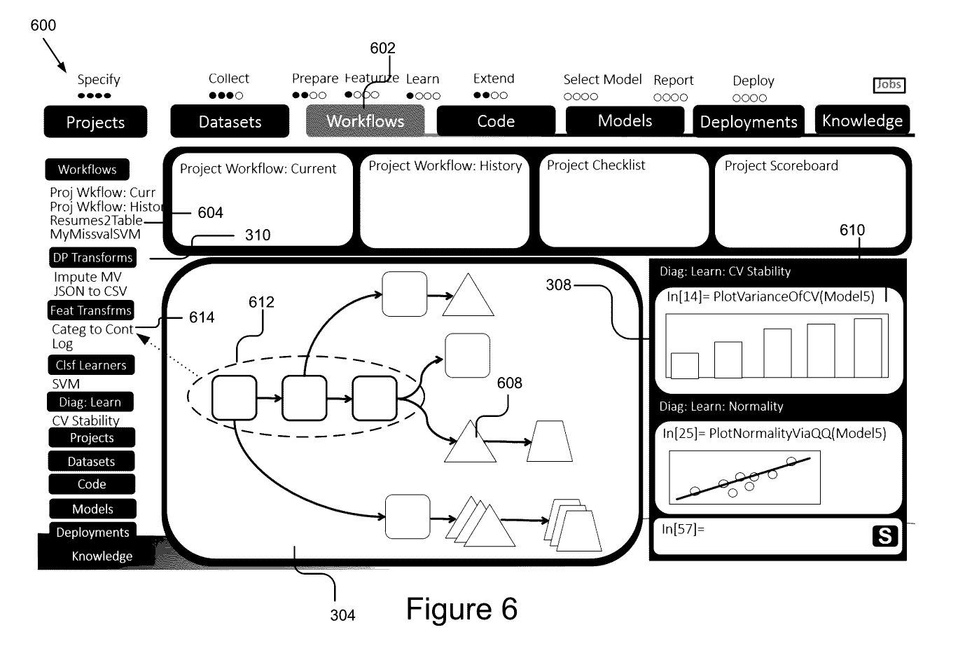

In some implementations, the user interface module 275 cooperates with the reporting module 265 to generate a user interface displaying dependencies of items and the interaction of the items (e.g., experiments, features, models, data sets, and projects) in a directed acyclic graph (DAG) view. The user interface module 275 receives information representing the DAG visualization from the reporting module 265 and generates a user interface as shown in the example of FIG. 6. For each node in the DAG, the reporting module 265 and the user interface module 275 cooperate to allow the user to select the node and retrieve associated information in the form one or more textual elements and/or report elements that indicate to the user a condition of the selected node. This provides the user with the ultimate level of flexibility in the project workspace. The user can see the node dependencies in the DAG and may choose to generate reports for a few of the nodes and include them into a report. In some implementations, a node in a DAG may be a grouping of related nodes and the user may zoom in or out of a node to receive varying levels of detail. For example, in featurization, a large number of datasets may be created by eliminating columns or groups of columns; in one embodiment, a single featurization node may be provided in the DAG and a user may optionally select to zoom into the node to see the various permutations eliminating one column at a time from the dataset, two columns from the data set, and so forth.

In some implementations, the user interface module 275 receives information including the audit trail from the auditing module 260 and generates a user interface as shown in the example of FIG. 3 which displays the rolling log of actions in the history space 308. In some implementations, the user interface module 275 cooperates with the model management module 255 to generate a user interface that provides the user with the ability to export a sub-workflow as a reusable card as shown in the example of FIG. 6. The user interface module 275 receives the selection (including via drag-and-drop) of the sub-workflow and updates the user interface to show the creation of abstract reusable card based on the sub-workflow.

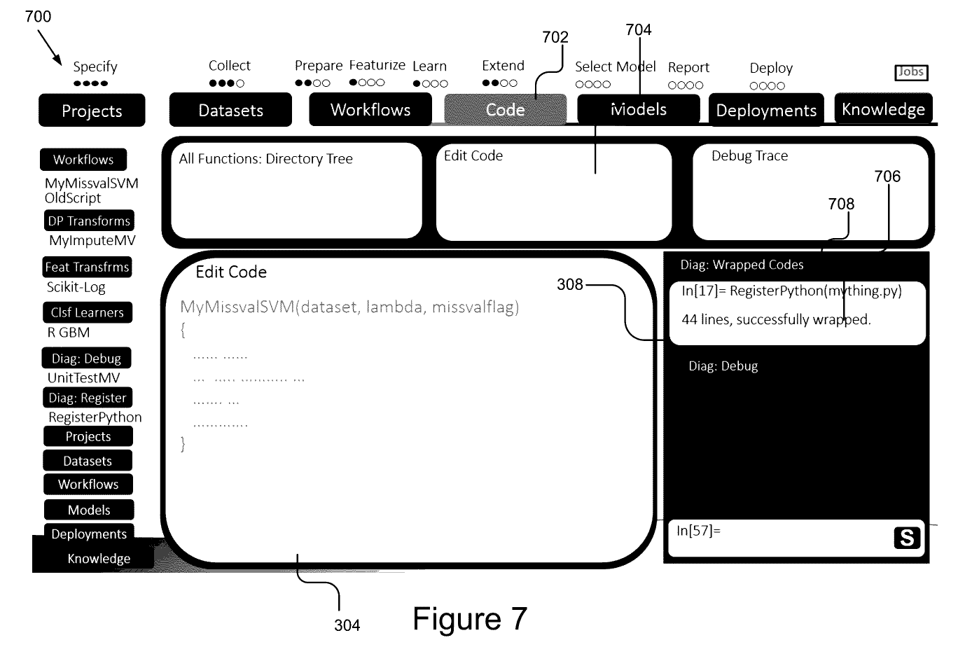

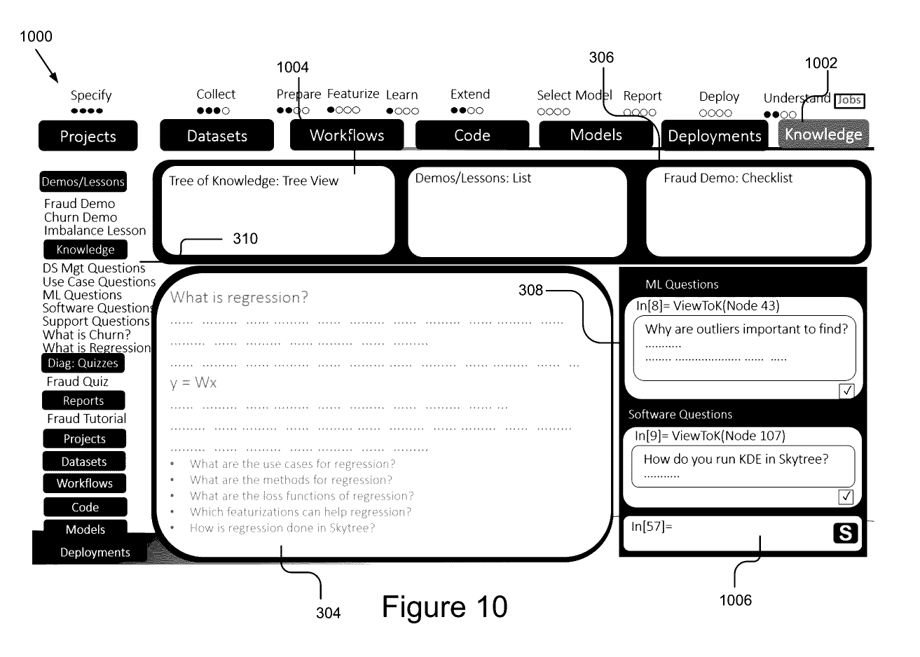

The user interface engine 275 generates one or more user interfaces oriented around a plurality of fundamental objects of machine learning/data science process. For example, FIG. 3 is an example user interface oriented around a “Projects” object. FIG. 4 illustrates an example user interface oriented around a “Datasets” object. FIG. 5 illustrates an example user interface oriented around a “Models” object. FIG. 6 illustrates an example user interface oriented around a “Workflows” object. FIG. 7 illustrates an example user interface oriented around a “Code” object. FIG. 8 illustrates an example user interface oriented around a “Deployments” object. FIG. 10 illustrates an example user interface oriented around a “Knowledge” object. It should be understood that the machine learning objects provided as examples are not exhaustive and that user interfaces oriented around other types of machine learning objects are contemplated in the techniques described herein. For example, a user interface oriented around a “Jobs” object (not shown) may present a list or table of the current computation jobs being run in the data science process and their state.

Referring to FIG. 3, the user interface 300 is oriented around “Projects” 302 as a machine learning object and highlighting different graphical components (e.g., cards) and their associated functionality. For example, the user selects element 316 for “Recruit POC” under the Projects heading on the left of the user interface 300, which updates the user interface 300 to orient around the selected proof of concept (POC) project. The user interface 300 includes various machine learning/data science areas or cards that are within reach of a user. The user interface 300 includes a set of selectable tabs grouped near the top of FIGS. 3-8 and 10-12 that are oriented around machine learning objects, such as projects, datasets, workflows, code, models, deployments, knowledge, jobs. For example, a user interface 300 facilitates a data scientist or user to reach the other user interfaces of corresponding machine learning objects from “Projects” 302. It should be understood that the names are illustrative and can be replaced with equivalent or related conceptual names. In some implementations, the user interface 300 includes all or a subset of the following screen areas or cards, which may appear anywhere on the display area of the user interface 300 and in any relative position with respect to each other: a main workspace card (the user is currently working on) 304, dashboard card 306, history card 308, card list or palette area 310. As such, it is noted that there can be multiple possible user interfaces or screens, each of which includes all or a subset of the aforementioned cards. Such user interfaces are specialized to show the cards oriented around the fundamental objects in machine learning/data science.

As shown in FIG. 3 on the bottom left, the user interface 300 provides a way for the user within the “Projects” specific screen to select objects from other screens, by encapsulating them in collapsible categories, in addition to the set of selectable tabs embedded near the top. In some implementations, the user may move all or a subset of cards (e.g., main workspace card 304, dashboard card 306, history card 308, palette area 310) between the screen areas on the user interface 300 which affects the appearance or functionality offered by the user interface 300. For example, the user selects a small dashboard card in the dashboard area 306 at the top which makes a larger version appear in the main workspace area 304 in the user interface 300. In another example, the user may move one of the cards from the palette area 310 or historical area 308 into the dashboard area 306, which makes the moved card live-updating within the user interface 300. In another example, the user moves a card from the historical area 308 into the main workspace area 304 which reproduces the information represented by the card so that e.g. the information may be modified or a process (e.g. transformation, plot generating, etc. represented by the card) may be run again within the user interface 300 on another or the same machine learning object. In another example, the user may move a card from the dashboard area 306 into the historical area 308. This action adds it to the report within the user interface 300. In another example, the user moves a card into the palette area 310 which generates and adds an abstract version of the card to the list of other cards in the palette area 310 within the user interface 300. In another example, the user selects an element or object of, for example, the workflow when shown on the “Projects” 302 tab, which brings the user over to the workflow page between screens or user interfaces. It should be noted that the above examples are some of the possible movements of cards/objects between the screen areas and the effect that each will have, other possible movements are possible and contemplated in the techniques described herein.

In some implementations, the main workspace card 304 is a screen object which is rectangular, either with corners or rounded edges, generally smaller than the standard screen size of the user interface 300, containing text and/or images. For example, the main workspace card 304 displays an associated input command accepted by the system, and the visual output of that command such as a plot or diagram or table or scoreboard, or its output in text form. In some implementations, the main workspace card 304 may include an area for the user to input a command or other inputs which specify a system action on one or more machine learning objects. The main workspace card 304 may include user-authorable cards that allow the specification of inputs in the manner of a form screen, and display actions taken based on the inputs. In some implementations, the main workspace card 304 may present a unified representation of all of the inputs of a workflow, comprising a concatenation of all of the inputs of cards in the workflow.

In some implementations, the dashboard card 306 may provide an at-a-glance view of one or more key performance indicators relevant to the context of the machine learning object. Any card from other screen areas can be placed into the dashboard area 306 for visualizing a dynamic and live-updating of such a card. For example, cards can be selected for inclusion in the dashboard area 306 (and the selection mechanism can include drag-and-drop into the dashboard area 306). When a card is shown in the dashboard area 306, it may be shown in one or more of a smaller, compressed, abbreviated, and vignette format. Examples of multiple cards in a dashboard include a machine learning/data science scoreboard, a workflow diagram, and a machine learning/data science checklist as shown in FIG. 3. In contrast, the cards can be selected for display (the selection mechanism including via drag-and-drop) in main workspace area 304 in which a card can be shown in an expanded or larger or more detailed format. When a card in the dashboard area 306 is selected for viewing in the main workspace area 304, the dashboard and/or list representation may be highlighted to show which current card is being displayed in the main workspace area 304. For example, as shown in FIG. 3, when the user selects a card 312 named “Project Workflow: Current” in the dashboard area 306, the user interface 300 highlights the card 312 and displays the card 312 in an expanded format in the main workspace area 304. In some implementations, the palette area 310 includes a list or palette of cards, which may include collapsible categories (and arbitrarily-deep hierarchies thereof), as shown on the left of FIG. 3.

The history area 308 is a machine learning/data science history area). The history area 308 is shown in FIG. 3 on the right and shows the temporally-ordered list of commands that have been issued by the user, whether programmatically or via the user interface 300. For example, as shown in FIG. 3, the history area 308 includes a bottommost card 314 into which the user may enter a new command programmatically. In some implementations, the history area 308 shows one or more individual cards. For example, a card associated with any command is shown in the history area. The commands in the form of individual cards may either appear in temporal order from top to bottom or bottom to top or left to right or right to left in the history area 308. In FIG. 3, the cards may appear in the history area 308 if generated by user actions in the user interface 300 or by automated actions. For example, the history area 308 may function as a log in addition to a place for the user to enter commands. In some implementations, the user may also select (the selection including via drag-and-drop) cards from other screen areas in FIG. 3 into the history area 308, which is a way to save snapshots of output at that moment into the log for reference later. For example, the user may save the current snapshot or picture of the workflow in the main workspace area 304 by dragging and dropping it into the history area 308. The snapshot may identify one or more of an input and output of the machine learning object in context. In some implementations, the user may also select the cards from the history area 806 and move them into the main workspace area 304. This action makes the cards editable so that they can be applied to new inputs. In some implementations the history area 308 may limit the number of cards associated with historical, or other actions, to a predetermined number (e.g. the 2 or 3 most recent actions). In some implementations, the history area 308 will include a mechanism for navigating through the historical commands (e.g. by using a scroll bar or buttons (not shown) that allows a user to scroll through the history in the history area 308).

FIG. 4 is a graphical representation of an example user interface 400 documenting one or more reports in the data science process. In FIG. 4, the user interface 400 is oriented around the “Datasets” 402 as a machine learning object. For example, the user selects a element 316 for “Resumes” dataset under the Datasets heading on the left of the user interface 400, which updates the user interface 400 to orient around the selected dataset. The user interface 400 includes a version of the main workspace area 304, the dashboard area 306, the history area 308, and the palette area 310 that are specific to the dataset object that the user interface 400 is oriented around. For example, the dataset-specific version of one or more of the areas 304, 306, 308, and 310 in the user interface 400 may include cards that are pre-classified to be related to the dataset object. In some implementations, the cards within one or more of the areas 304, 306, 308, and 310 in the user interface 400 are in collapsible categories (and arbitrarily-deep hierarchies thereof). The user interface 400 displays the dashboard area 306 which includes features (an additional type of object within the dataset) that are generated for the dataset object as a “Features: Table” card 402. When the user selects the card 402 for inclusion (e.g., via drag and drop) into the main workspace area 304, the main workspace area 304 is updated to display an expanded view of the table of features in the card 402. In some embodiments, the history area may be filtered based on the machine learning object around which the user interface is oriented. For example, in one embodiment, the history area 308 may be filtered to include only those cards related to actions on the dataset(s) (e.g., plotting the dataset, plotting outliers, transformations done to the data set, etc.)

Regardless, as illustrated, the user interface 400 includes one or more cards in the history area 308 that may be individually selectable by the user for inclusion in a report for the project involving the dataset object. The one or more cards in the history area 308 may be organized by report topic and may include a diagnostics report for project checklist (see below for more detailed description). For example, the user may select the explicit features report topic card 404 in the history area 308 by checking the box for inclusion into the report. The explicit features report topic card 404 shows a plot of the missing values by features which gives the user an indication of a quality of the dataset(s) used in the data science process for the user's current project. In some implementations, the report generation may be set up by the user in such a way as to automatically document everything the user has performed on the dataset and include such documentation as a report. Such implementations may beneficially provide an audit trail.

Referring now also to graphical representation in FIG. 5, the user interface 500 displays report selection that can be specified via the inclusion or exclusion of desired report elements. In FIG. 5, the user interface 500 is oriented around the “Models” 502 as a machine learning object. In addition to the user specifying one or more cards for inclusion into reports by selecting the cards as previously described in FIG. 4, the user interface 500 illustrates that the user can select report elements for inclusion in a report by selecting them through a visual representation of the report elements on a workflow visualization as shown in main workspace area 304. In FIG. 5, the user selects the “Exec Report” tab 504, which updates the user interface 500 to display a visualization of the workflow in the main workspace area 304. The visualization of the workflow is a directed acyclic graph view of the workflow and includes one or more rectangular boxes 506 between the nodes of the directed acyclic graph view of the workflow. The rectangular box 506 represents a report element visually for the user to select for inclusion in the report. The user interface 500 displays a checkbox 508 next to the report topic outliers in the history area 308. The user may check the checkbox 508 for inclusion of the entire report topic “outliers” into the report. Alternatively, the user may check the checkbox 510 for selectively including a report element from the report topic outliers into the report. A report topic template may have many sub-topics (report elements), and user can decide to include entire topic or specific sub-topics (elements). In some implementations, the reports may be printed on the screen, but also may be exported to sharable forms such as PDF, PowerPoint, or a proprietary format. For example, a data scientist may select the entire “outliers” topic for inclusion in a report going to a non-technical reader, so that reader may understand to what an outlier refers, the significance of an outlier, and how the outliers were dealt with, while, the data scientist may select to selectively only include the plot of outliers for a report going to the data scientist's team, since the team, presumably, know and does not need the additional background information regarding outliers and/or is only interested in a particular plot of the outliers.

FIG. 6 is a graphical representation of an example user interface 600 displaying creation of reusable card for inclusion in the palette area 310. In FIG. 6, the user interface 600 is oriented around “Workflows” 602 as a machine learning object. For example, the user selects element 604 for “Resumes2Table” workflow under the Workflows heading on the left of the user interface 600, which updates the user interface 600 to orient around the selected workflow and includes a representation of the selected workflow in the main workspace area 304. The representation of the selected workflow is user interactive in the main workspace area 304. For example, when the user selects a node 608 representing a model, the user interface 600 highlights the diagnostic report card 610 associated with the model within the history area 308 for user attention. For example, the diagnostics report card 610 includes a plot of an aspect of the model which the user can review to understand data of the model and its quality (i.e., model interpretation). In addition, the user interface 600 shows how objects from within any one or more of the cards or areas can be manipulated and moved into the palette area 310. This effectively saves, for example, the command represented by the card as a reusable object in the palette area 310. For example, the user may select a sub-workflow 612 within a workflow card represented by the main workspace area 304 for inclusion in the palette area 310. The user can select the sub-workflow 612 including via interactive dragging-and-dropping for inclusion into the palette area 310. This saves the sub-workflow 612 as a reusable abstract workflow 614 at a high level abstract object (i.e. one that is not specific to the inputs it is currently operating upon) so that it may be applied to another input (e.g., a new or different model instance, new or different dataset instance, new or different workflow instance, etc.) as long as it is applicable to that input. This placement of an object/card in the card list/palette area 310 also allows the user convenient access to it in the future. In some implementations, the user may share the reusable object from the palette area 310 with other users involved in a collaboration on a project. Taking the sub-workflow 612 as another example, the user may select the sub-workflow 612 for inclusion in the report and move it interactively into the history area 308. In yet another example, the user can select the diagnostic report card 610 and move it interactively into the palette area 310 to create a reusable abstract diagnostic report card.

FIG. 7 is a graphical representation of an example user interface 700 associated with code in a data science process. In FIG. 7, the user interface 700 is oriented around “Code” 702 as a machine learning object. In the user interface 700, the user selects the Edit Code card 704 in the dashboard area to bring the code for editing to the foreground in the main workspace area 304. For example, the user can write complex code sequences for and define a function “MyMissvalSVM” in the main workspace area 304. The user interface 700 also includes diagnostic report card 706 in the history area 308 which points to the successful wrapping of a “RegisterPython” code and the user can check the box 708 to include the diagnostic report card 706 in a report.

FIG. 8 is a graphical representation of an example user interface 800 tracking models in deployment. The user interface 800 is oriented around “Deployment” 802 as a machine learning/data science object. The user interface 800 in the main workspace area 304 shows the list of, and current state of, all models which are currently in deployment, i.e. functioning in server mode serving predictions when requests for predictions are made. For example, the user selects element 804 for “Scorebd: Train vs Live” which results in the main workspace 304 bringing a machine learning/data science scoreboard to the foreground as shown in FIG. 3. Within the scoreboard, the user may identify how a particular model “LiveJuneSVM” is faring on deployment by selecting the element 806 for “LiveJuneSVM” under the Deployments heading to the left of the user interface 800. The row 808 for model “LiveJuneSVM” in the scoreboard is then highlighted (not shown) in the main workspace area 304 in response to the user selecting element 806. In the user interface 800, the model “LiveJuneSVM” can be a steady state model deployed and/or updated using new and/or old training data for the month of June.

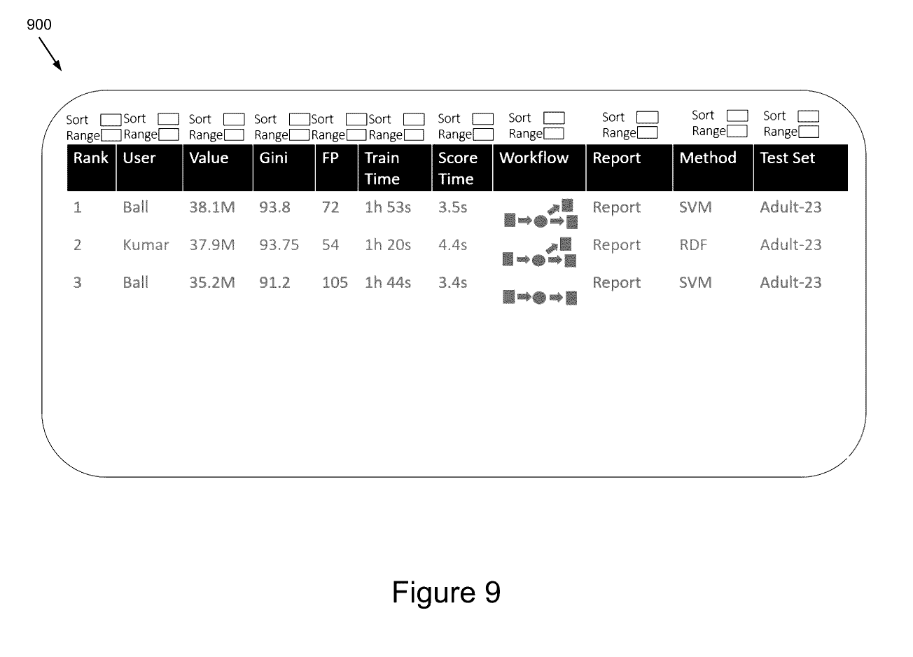

Referring to FIG. 9, the graphical representation includes another example user interface 900 depicting a machine learning/data science scoreboard. In the illustrated example, the machine learning/data science scoreboard is a table where each row represents a model, and columns include one or more measures of model quality or other information about the model. Examples of model quality may include, but is not limited to, predictive accuracy, size, training time, scoring time, etc. The table can be sorted and filtered in any of the normal ways including by specifying ranges, and will be commonly useful for seeing the models sorted by predictive accuracy. Some cards, such as the dashboard area 306 in the user interface 800 in FIG. 8 can be dynamically updated on the screen as their underlying data changes. One of the quantities in a scoreboard can be the abstract or dollar value/cost associated with each model; such model values/costs can thus be included in reports via including scoreboards in reports, as well as by other means. The scoreboards can serve as a means to visualize and aid in collaboration or competition, between the models made by the same user over time or between models made by different users or groups.

FIG. 10 is a graphical representation of an example user interface 1000 depicting a knowledge base in the data science process. In FIG. 10, the user interface 1000 is oriented around “Knowledge” 1002 as a machine learning object. The user interface 1000 includes a machine learning or data science knowledge representation as shown in FIG. 10. In the palette area 310, the user interface 1000 represents the knowledge in the form of cards. The cards may include questions, text and/or pictures. Such knowledge cards may have the interaction properties of other cards as previously described. For example, they can be included as selectable report elements in reports, placed in dashboards and palettes, etc. A selection of the card from the palette area 310 includes the card-sized/summary answer to that question, sub-questions, and related questions. In some implementations, each sub-question and related question contains its own card-sized/summary answer recursively, forming a directed graph of questions and answers, and generalizing the familiar list of “frequently asked questions” to a form which may be all or mostly hierarchical but more generally a navigable graph. For example, the user interface 1000 represents the above navigable graph as a “Tree of Knowledge: Tree View” card 1004 in the dashboard area 306. When the user selects the card 1004, the tree view represented by the card 1004 can be explored by the user in detail in the main workspace area 304. If the user were to select to view “What is regression?” knowledge card in the navigable graph, then the user interface 1000 expands that question and answer card in the main workspace area 304 for the user to review. The user may view a node of this graph, navigate to sub-questions, related questions, and parent questions, create his/her own node, edit a node, or annotate a node. Alternatively, the user may access the knowledge base programmatically in the history area 308. For example, the user types a query into the command prompt 1006 to search the knowledge base and the history area 308 outputs individual cards including card-sized/summary answer for each query. In another example, the user may define a knowledge node in the graph by composing a sequence of codes in the command prompt 1006. In some implementations, the representation of machine learning or data science knowledge may also appear as a website in the user interface 1000.

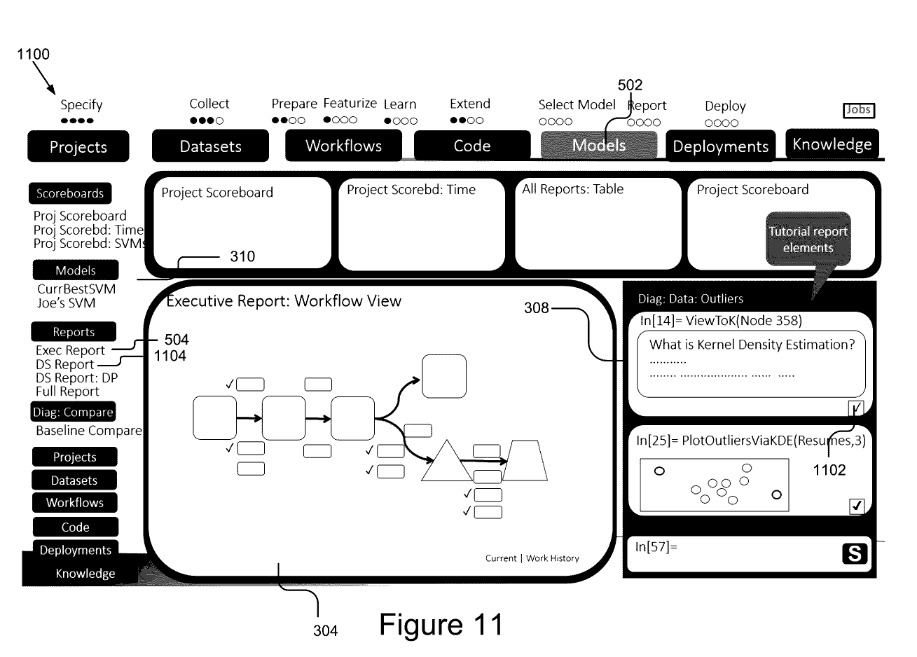

Referring to graphical representation in FIG. 11, the user interface 1100 depicts inclusion of one or more knowledge base entries from the knowledge base into a report. The user interface 1100 is a modified version of the user interface 500 in FIG. 5. As previously described, the user may pick out a knowledge base entry element in the directed acyclic graph view of the workflow shown in the main workspace area 304 and include into the report. Alternatively, the user can check the box 1102 in the history area 308 to include the knowledge base entry for “What is Kernel Density Estimation” into the report. A knowledge base entry can be described as a ready-made description of various types of activities undertaken in the data science process, for example, data transformations, model generation, etc. The user may include a knowledge base entry into the report for the end user to understand the data science process involved in the workflow. The end user may be a novice or a non-data science user. In some implementations, the type of report template that is chosen by the user in the user interface 1100 can affect what kind of knowledge base entry are included in the report. For example, as shown in the palette area 310 in FIG. 11, there are several selectable report templates under the collapsible category of Reports tab. An executive report template 504 can differ from a data scientist report template 1104. For example, as discussed above, an executive report template may have more high level information about what an outlier is and how they were dealt with, while the data scientist report template may plot include a plot of the outliers or provide greater statistical insight beyond what an executive may understand or want to know. In some embodiments the different report templates or types of report templates shown under the Reports tab may be learned or modified based on learning from user interactions (e.g. the system learns that User A generally wants X in type Y report, or similar users generally include X in type Y report, so the template for type Y report includes X).

FIG. 12 is a graphical representation of an example user interface 1200 that displays a next action suggestion to a user in the data science process. The user interface 1200 includes a machine learning/data science next-action suggestion in the data science process. In the user interface 1200, the user may select the option 1202 (which may appear as graphical element, such as a button or other interaction cue) to instruct the data science process to suggest a next action for the user. Upon the user doing so, the user interface 1200 may show the suggestion 1204 for the project workflow in the main workspace area 304. In some implementations, the user interface 1200 may optionally provide one or more of a preview of the effect of the suggested action, background or help material informing, instructing, and/or teaching the user about the details of the suggested action, an option to select the action suggested or other additional actions. In some implementations the suggested action is performed without asking the user for user verification. In some implementations, the user is provided the result of the action, and parts of the user interface 1200 corresponding to the suggested action are highlighted in order to show what changes resulted from the action. In some implementations parts of the user interface 1200 corresponding to the suggested action are highlighted to guide the user through manual implementation of the suggested action. The suggestion by the user interface 1200 may do any subset of the above actions, depending on one or more of the implementation and on user preferences, which the user may be able to select.

In some implementations, the user interface 1200 may accommodate a machine learning or data science guided teaching or learning. The next-action suggestion interaction mechanism in the user interface 1200 can be used as a teaching or learning system. The user can specify or request a sequence of actions in the user interface 1200 to suggest, thus constituting the equivalent of a lesson or demo, wherein the user interface 1200 steps the user through one or both of the knowledge elements and the associated software and/or machine learning actions. The user learns via the user interface 1200 by doing as per the suggestions. For example, the user may select the option 1202 at one or more junctures of the data science process to receive one or more suggestion of next actions to perform. In some implementations, the user interface 1200 may gather the actions performed by the user for learning. For example, the user may be allowed to perform actions other than the one the user interface 1200 has suggested, in order to allow a non-linear teaching/learning experience. In some implementations, the user interface 1200 may request a confirmation from the user that the user has read a knowledge element in the demo which the user interface 1200 presented to the user via the main workspace area 304. The user interface 1200 may present a question or a series of question, i.e., a quiz, to test learning of the knowledge. The user interface 1200 may change the next action suggestion based on the user answers.

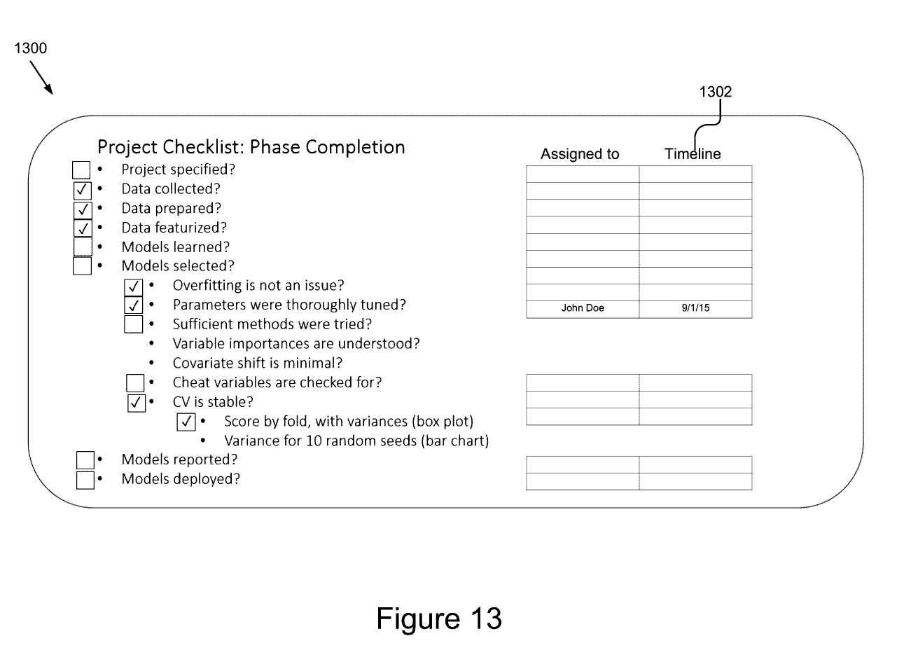

FIG. 13 is a graphical representation of an example user interface 1300 depicting a machine learning or data science diagnostic checklist. As illustrated in the FIGS. 3-8, and 10-12, the top of the user interfaces show a list of multi-selectable items which represent phases of analytics work and/or analytics diagnostics. The phases of analytics work are parts of the overall analytics work in a project. For example, project specification, data collection, data preparation, data featurization, training of models, selection of models, reporting of models, and deployment of models. Referring to FIG. 13, the user interface 1300 provides a way to create or modify a checklist, and view the status of a checklist. The status of the checklist indicates which items have been checked off, and when, and by whom. The illustrated checklist includes an optional timeline 1302 by which the items should be checked off. In FIGS. 3-8, and 10-12, the corresponding user interfaces show the checklist in a horizontal or vertical fashion, indicating the overall progress of the machine learning/data science project.

One of the checklist items can be the specification of the project. This includes the project's primary objective, which is a quantitative metric such as predictive accuracy, and may include constraints based on other metrics. For example, the metric can be the scoring time of the final model must be less than a specified threshold. The metric may be a metric which combines multiple metrics, for example, a weighted combination of more than one quantitative values. The checklist may also include values/costs such as the entries in a classification cost matrix. The checklist may also include the specification of the generalization mechanism, for example, a 10-fold cross-validation. The checklist may be hierarchically, i.e. a diagnostic may itself consist of sub-diagnostics which check more detailed issues. Another one of the checklist items can be diagnostic questions. Diagnostics are validation steps which are prescribed as necessary or desirable to perform, for example, checking for the presence of outliers in the training data. Each diagnostic included in the checklist may include a set of visualizations/plots to be created, a set of statistics to be computed, and thresholds or other conditions on those statistics that define whether the diagnostic has been passed (or any subset of these three). In some implementations, the selection of report elements (e.g., visualizations, plots, etc.) for inclusion in the report can be done through the specification of the project checklist.

### Example Methods

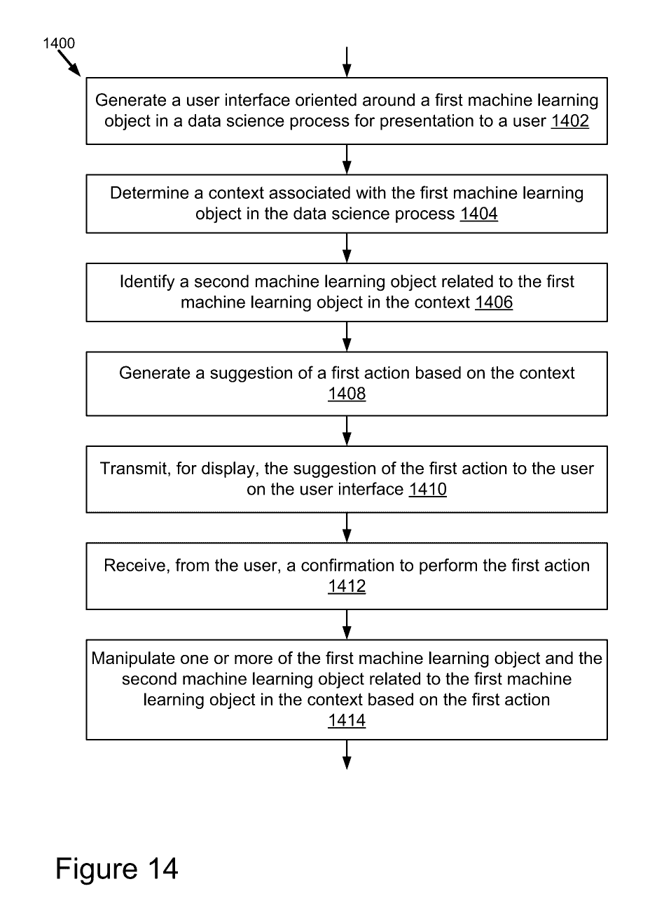

FIG. 14 is a flowchart of an example method 1400 for guiding a user through a data science process of a machine learning object, in accordance with one implementation of the present disclosure. At block 1402, the user interface module 275 generates a user interface oriented around a first machine learning object in a data science process for presentation to a user. At block 1404, the suggestion module 270 determines a context associated with the first machine learning object in the data science process. At block 1406, the suggestion module 270 identifies a second machine learning object related to the first machine learning object in the context. At block 1408, the suggestion module 270 generates a suggestion of a first action based on the context. At block 1410, the user interface module 275 transmits, for display, the suggestion of the first action to the user on the user interface. At block 1412, the user interface module 275 receives, from the user, a confirmation to perform the first action. At block 1414, the project module 245 manipulates one or more of the first machine learning object and the second machine learning object related to the first machine learning object in the context based on the first action.

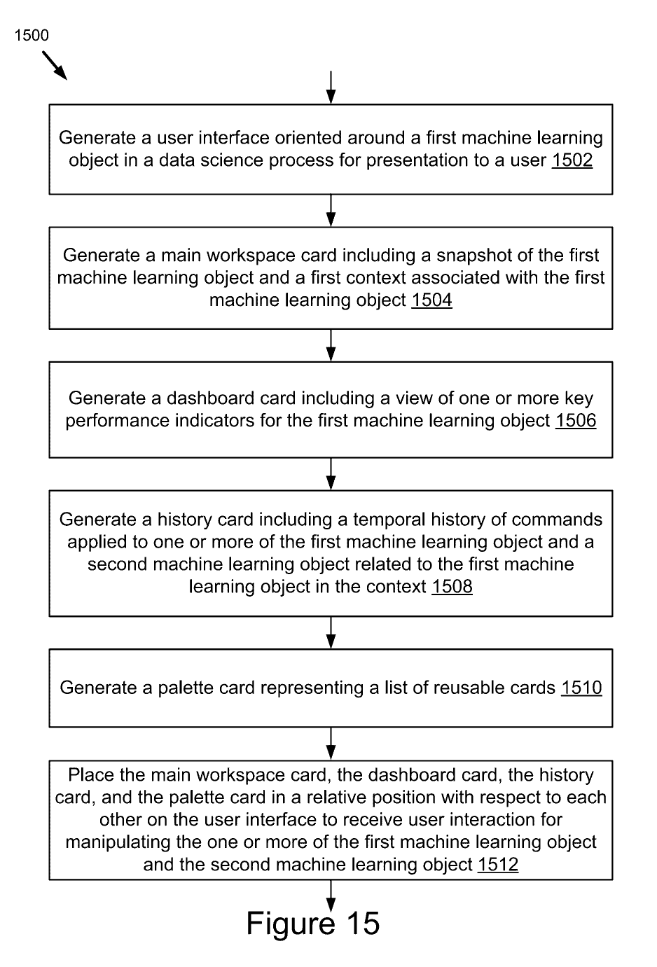

FIG. 15 is a flowchart of an example method 1500 for generating a user interface for facilitating a data science process of a machine learning object, in accordance with one implementation of the present disclosure. At block 1502, the user interface module 275 generates a user interface oriented around a first machine learning object in a data science process for presentation to a user. At block 1504, the user interface module 275 generates a main workspace card including a snapshot of the first machine learning object and a first context associated with the first machine learning object. At block 1506, the user interface module 275 generates a dashboard card including a view of one or more key performance indicators for the first machine learning object. At block 1508, the user interface module 275 generates a history card including a temporal history of commands applied to one or more of the first machine learning object and a second machine learning object related to the first machine learning object in the context. At block 1510, the user interface module 275 generates a palette card representing a list of reusable cards. At block 1512, the user interface module 275 places the main workspace card, the dashboard card, the history card, and the palette card in a relative position with respect to each other on the user interface to receive user interaction for manipulating the one or more of the first machine learning object and the second machine learning object.

The foregoing description of the implementations of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As should be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present disclosure may be implemented as software, hardware, firmware or any combination of the three. Also, wherever a component, an example of which is a module, of the present disclosure is implemented as software, the component may be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the present disclosure, which is set forth in the following claims.

What is claimed is:

1. A method comprising:
generating, using one or more processors, a user interface for presentation to a user, the user interface oriented around a first machine learning object in a data science process;
determining, using the one or more processors, a first context associated with the first machine learning object in the data science process;
identifying a second machine learning object related to the first machine learning object in the first context;
generating, using the one or more processors, a suggestion of a first action based on the first context;
transmitting, using the one or more processors, for display, the suggestion of the first action to the user on the user interface;
receiving, using the one or more processors, from the user, a confirmation to perform the first action; and
manipulating, using the one or more processors, one or more of the first machine learning object and the second learning object related to the first machine learning object in the first context based on the first action.

2. The method of claim 1, wherein generating the user interface further comprises:
generating a main workspace card including a snapshot of the first machine learning object and the first context associated with the first machine learning object in the data science process, the snapshot identifying one or more of an input and output of the first machine learning object;
generating a dashboard card including a dynamic view of one or more key performance indicators for the first machine learning object in the data science process;
generating a history card including a temporal history of commands applied to the one or more the first machine learning object and the second machine learning object related to the first machine learning object in the first context;
generating a palette card including a list of reusable cards in the data science process; and
placing the main workspace card, the dashboard card, the history card, and the palette card in a relative position with respect to each other on the user interface to receive user interaction for manipulating the one or more of the first machine learning object and the second machine learning object.

3. The method of claim 1, wherein determining the first context associated with the first machine learning object includes determining a first analysis phase of the first machine learning object and a history of analysis associated with the one or more of the first machine learning object and the second machine learning object related to the first machine learning object in the first context.

4. The method of claim 3, wherein generating the suggestion of the first action includes identifying a second action previously performed on another instance of the first machine learning object in a second analysis phase within a second context in the data science process, wherein the second analysis phase and the second context is identical to the first analysis phase and the first context, and first action is learned based on the second action.

5. The method of claim 1, wherein generating the suggestion of the first action includes selecting the suggestion based on one or more of seeded suggestions, heuristics, and a set of best practices in the data science process.

6. The method of claim 1, wherein transmitting the suggestion of the first action to the user includes displaying a preview of an effect of the first action on the one or more of the first machine learning object and the second machine learning object related to the first machine learning object in the first context.

7. The method of claim 1, further comprising generating a checklist for the data science process based on one or more of learning from a previous checklist, seeded checklists, heuristics, and a set of best practices, the checklist identifying an overall progress of the data science process.

8. The method of claim 1, wherein the suggestion of the first action includes a sequence of actions comprising one or more of a demo, a lesson, and a tutorial for guiding the user in the data science process.

9. The method of claim 1, wherein the first machine learning object includes one or more from a group of projects, datasets, workflows, code, model, deployment, knowledge, and jobs.

10. The method of claim 1, further comprising generating one or more report elements for inclusion in a report for the data science process responsive to receiving the confirmation to perform the first action.

11. The method of claim 1, further comprising generating a documentation of the first action in the data science process responsive to receiving the confirmation to perform the first action.

12. A system comprising:
one or more processors; and
a memory including instructions that, when executed by the one or more processors, cause the system to:
generate a user interface for presentation to a user, the user interface oriented around a first machine learning object in a data science process;
determine a first context associated with the first machine learning object in the data science process;
identify a second machine learning object related to the first machine learning object in the first context;
generate a suggestion of a first action based on the first context;
transmit, for display, the suggestion of the first action to the user on the user interface;
receive, from the user, a confirmation to perform the first action; and
manipulate one or more of the first machine learning object and the second learning object related to the first machine learning object in the first context based on the first action.

13. The system of claim 12, wherein the instructions to generate the user interface, when executed by the one or more processors, cause the system to:
generate a main workspace card including a snapshot of the first machine learning object and the first context associated with the first machine learning object in the data science process, the snapshot identifying one or more of an input and output of the first machine learning object;
generate a dashboard card including a dynamic view of one or more key performance indicators for the first machine learning object in the data science process;
generate a history card including a temporal history of commands applied to the one or more the first machine learning object and the second machine learning object related to the first machine learning object in the first context;
generate a palette card including a list of reusable cards in the data science process; and
place the main workspace card, the dashboard card, the history card, and the palette card in a relative position with respect to each other on the user interface to receive user interaction for manipulating the one or more of the first machine learning object and the second machine learning object.

14. The system of claim 12, wherein the instructions to determine the first context associated with the first machine learning object, when executed by the one or more processors, cause the system to determine a first analysis phase of the first machine learning object and a history of analysis associated with the one or more of the first machine learning object and the second machine learning object related to the first machine learning object in the first context.

15. The system of claim 14, wherein the instructions to generate the suggestion of the first action, when executed by the one or more processors, cause the system to identify a second action previously performed on another instance of the first machine learning object in a second analysis phase within a second context in the data science process, wherein the second analysis phase and the second context is identical to the first analysis phase and the first context, and first action is learned based on the second action.

16. The system of claim 12, wherein the instructions to generate the suggestion of the first action, when executed by the one or more processors, cause the system to select the suggestion based on one or more of seeded suggestions, heuristics, and a set of best practices in the data science process.

17. A computer-program product comprising a non-transitory computer usable medium including a computer readable program, wherein the computer readable program, when executed on a computer, causes the computer to perform operations comprising:
generating a user interface for presentation to a user, the user interface oriented around a first machine learning object in a data science process;
determining a first context associated with the first machine learning object in the data science process;
identifying a second machine learning object related to the first machine learning object in the first context;
generating a suggestion of a first action based on the first context;
transmitting, for display, the suggestion of the first action to the user on the user interface;
receiving, from the user, a confirmation to perform the first action; and
manipulating one or more of the first machine learning object and the second learning object related to the first machine learning object in the first context based on the first action.

18. The computer program product of claim 17, wherein the operations for generating the user interface further comprise:
generating a main workspace card including a snapshot of the first machine learning object and the first context associated with the first machine learning object in the data science process, the snapshot identifying one or more of an input and output of the first machine learning object;
generating a dashboard card including a dynamic view of one or more key performance indicators for the first machine learning object in the data science process;
generating a history card including a temporal history of commands applied to the one or more the first machine learning object and the second machine learning object related to the first machine learning object in the first context;
generating a palette card including a list of reusable cards in the data science process; and
placing the main workspace card, the dashboard card, the history card, and the palette card in a relative position with respect to each other on the user interface to receive user interaction for manipulating the one or more of the first machine learning object and the second machine learning object.

19. The computer program product of claim 17, wherein the operations for determining the first context associated with the first machine learning object further include determining a first analysis phase of the first machine learning object and a history of analysis associated with the one or more of the first machine learning object and the second machine learning object related to the first machine learning object in the first context.

20. The computer program product of claim 19, wherein the operations for generating the suggestion of the first action include identifying a second action previously performed on another instance of the first machine learning object in a second analysis phase within a second context in the data science process, wherein the second analysis phase and the second context is identical to the first analysis phase and the first context, and first action is learned based on the second action.
